(19) United States
(12) Patent Application Publication
(10) Pub. No.: US 2023/0353311 A1
(43) Pub. Date: Nov. 2, 2023

(54) PORT GROUPING FOR A CHANNEL STATE INFORMATION-REFERENCE SIGNAL (CSI-RS) RESOURCE

(71) Applicant: QUALCOMM Incorporated, San Diego, CA (US)

(72) Inventors: Mostafa KHOSHNEVISAN, San Diego, CA (US); Chenxi HAO, Beijing (CN); Xiaoxia ZHANG, San Diego, CA (US)

(21) Appl. No.: 17/922,942

(22) PCT Filed: Jun. 27, 2020
(86) PCT No.: PCT/CN2020/098342

§ 371 Date: Nov. 2, 2022

(51) Int. Cl. H04L 5/00; H04B 7/06

(52) U.S. Cl. CPC H04L 5/0051; H04B 7/0639

(57) ABSTRACT

Aspects of the disclosure relate to methods and apparatus that involve associating a first plurality of channel state information-reference signal (CSI-RS) ports with a second plurality of transmission configuration indicator (TCI) states according to a rule at a scheduling entity, mapping the first plurality of CSI-RS ports to antenna elements of an antenna array in accordance with the rule, and transmitting CSI-RS to a scheduled entity, receiving CSI-RS at the scheduled entity and associating the first plurality of CSI-RS ports with the second plurality of transmission configuration indicator (TCI) states according to a rule at the scheduled entity, determining pre-coding matrix indicators (PMIs) corresponding to the second plurality of TCI states, and transmitting the PMIs corresponding to the second plurality of TCI states to the scheduling entity. Other aspects, embodiments, and features are also claimed and described.

### TECHNICAL FIELD

The technology discussed below relates generally to wireless communication systems, and more particularly, to associations between channel state information-reference signal (CSI-RS) ports and multiple transmission configuration indicator (TCI) states to facilitate port grouping for the CSI-RS resource.

### INTRODUCTION

A channel state information-reference signal (CSI-RS) resource may be configured by a scheduling entity (e.g., a base station) with a predetermined number of CSI-RS ports. The scheduling entity may transmit CSI-RS resources to a scheduled entity (e.g. a user equipment (UE)). The scheduled entity may determine channel quality by measurement of received CSI-RS resources and may return a channel state information (CSI) report including, for example, a channel quality indicator (CQI), a precoding matrix indicator (PMI) and/or rank indicator (RI) to the scheduled entity in view of the channel quality measurement. Each CSI-RS resource may be associated with one transmission configuration indicator (TCI) state. However, and by example, scheduled entities may be configured to receive signals from multiple transmission reception points (multi-TRPs), where each of the multi-TRPs may have a different TCI state.

As the demand for wireless communication increases, research and development continue to advance the communication technologies field. For example, techniques related to CSI-RS port grouping, to allow multiple TCI states to be associated with multiple CSI-RS resources, may be useful, particularly for multi-TRP wireless communication network operation.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method of wireless communication of a scheduling entity in a wireless communication network is disclosed. The method includes associating a first plurality of channel state information-reference signal (CSI-RS) ports with a second plurality of transmission configuration indicator (TCI) states according to a rule, mapping the first plurality of CSI-RS ports to antenna elements of an antenna array in accordance with the rule, transmitting a respective CSI-RS on each of the first plurality of CSI-RS ports from the antenna array to a scheduled entity, and receiving a third plurality of pre-coding matrix indicators (PMIs) corresponding to the second plurality of TCI states, respectively, from the scheduled entity.

According to another example, a wireless communication device in a wireless communication network is disclosed. The wireless communication device includes a wireless transceiver, a memory, and a processor communicatively coupled to the wireless transceiver and the memory. According to one aspect, the processor and the memory are configured to associate a first plurality of channel state information-reference signal (CSI-RS) ports with a second plurality of transmission configuration indicator (TCI) states according to a rule, map the first plurality of CSI-RS ports to antenna elements of an antenna array in accordance with the rule, transmit a respective CSI-RS on each of the first plurality of CSI-RS ports from the antenna array to a scheduled entity, and receive a third plurality of pre-coding matrix indicators (PMIs) corresponding to the second plurality of TCI states, respectively, from the scheduled entity.

In another example, a wireless communication device configured for use in a wireless communication network is disclosed. The wireless communication device includes means for associating a first plurality of channel state information-reference signal (CSI-RS) ports with a second plurality of transmission configuration indicator (TCI) states according to a rule, means for mapping the first plurality of CSI-RS ports on each of the first plurality of CSI-RS ports from the antenna array to a scheduled entity, means for transmitting a respective CSI-RS on each of the first plurality of CSI-RS ports from the antenna array to a scheduled entity, and means for receiving a third plurality of pre-coding matrix indicators (PMIs) corresponding to the second plurality of TCI states, respectively, from the scheduled entity.

In still another example, an article of manufacture for use by a wireless communication device in a wireless communication network is disclosed. According to one aspect, the article of manufacture includes a non-transitory computer-readable medium having stored therein instructions executable by one or more processors of the wireless communication device. The instruction include instructions to associate a first plurality of channel state information-reference signal (CSI-RS) ports with a second plurality of transmission configuration indicator (TCI) states according to a rule, map the first plurality of CSI-RS ports to antenna elements of an antenna array in accordance with the rule, transmit a respective CSI-RS on each of the first plurality of CSI-RS ports from the antenna array to a scheduled entity, and receive a third plurality of pre-coding matrix indicators (PMIs) corresponding to the second plurality of TCI states, respectively, from the scheduled entity.

In another example, a method of wireless communication of a scheduled entity in a wireless communication network is disclosed. The method includes receiving a respective channel state information-reference signal (CSI-RS) on each of a first plurality of CSI-RS ports from a scheduling entity, associating the first plurality of CSI-RS ports with a second plurality of transmission configuration indicator (TCI) states according to a rule, determining a third plurality of pre-coding matrix indicators (PMIs) corresponding to the second plurality of TCI states, respectively, and transmitting the third plurality of pre-coding matrix indicators (PMIs) corresponding to the second plurality of TCI states, respectively, to the scheduling entity.

According to another example, a wireless communication device in a wireless communication network is disclosed. According to one aspect. the wireless communication device includes a wireless transceiver, a memory, and a processor communicatively coupled to the wireless transceiver and the memory. According to one aspect, the processor and the memory are configured to receive a respective channel state information-reference signal (CSI-RS) on each of a first plurality of CSI-RS ports from a scheduling entity, associate the first plurality of CSI-RS ports with a second plurality of transmission configuration indicator (TCI) states according to a rule, determine a third plurality of pre-coding matrix indicators (PMIs) corresponding to the second plurality of TCI states, respectively, and transmit the third plurality of pre-coding matrix indicators (PMIs) corresponding to the second plurality of TCI states, respectively, to the scheduling entity.

In still another example, a wireless communication device configured for use in a wireless communication network is disclosed. According to one aspect the wireless communication device includes means for receiving a respective channel state information-reference signal (CSI-RS) on each of a first plurality of CSI-RS ports from a scheduling entity, means for associating the first plurality of CSI-RS ports with a second plurality of transmission configuration indicator (TCI) states according to a rule, means for determining a third plurality of pre-coding matrix indicators (PMIs) corresponding to the second plurality of TCI states, respectively, and means for transmitting the third plurality of pre-coding matrix indicators (PMIs) corresponding to the second plurality of TCI states, respectively, to the scheduling entity.

In another example, an article of manufacture for use by a wireless communication device in a wireless communication network is disclosed. The article of manufacture includes a non-transitory computer-readable medium having stored therein instructions executable by one or more processors of the wireless communication device. The instructions include instructions to receive a respective channel state information-reference signal (CSI-RS) on each of a first plurality of CSI-RS ports from a scheduling entity, associate the first plurality of CSI-RS ports with a second plurality of transmission configuration indicator (TCI) states according to a rule, determine a third plurality of pre-coding matrix indicators (PMIs) corresponding to the second plurality of TCI states, respectively, and transmit the third plurality of pre-coding matrix indicators (PMIs) corresponding to the second plurality of TCI states, respectively, to the scheduling entity.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is a schematic illustration of an organization of wireless resources in an air interface utilizing orthogonal frequency divisional multiplexing (OFDM) according to some aspects of the disclosure.

FIG. 4 is a block diagram illustrating an example of a wireless communication system supporting beamforming and/or multiple-input multiple-output (MIMO) communication according to some aspects of the disclosure.

FIG. 5 is a schematic diagram demonstrating physical layer mapping of logical antenna ports to physical antenna elements according to some aspects of the disclosure.

FIG. 6 is a schematic diagram illustrating a portion of the plurality of antenna elements of the antenna array of FIG. 5, and a scheduled entity, according to some aspects of the disclosure.

FIGS. 7A, 7B, and 7C are schematic illustrations of an organization of resource elements in an air interface utilizing orthogonal frequency divisional multiplexing (OFDM) according to some aspects of the disclosure.

FIG. 8 is a schematic diagram illustrating relationships between an organization of resource elements, CSI-RS ports, CDM groups, TCI states, and reporting modes according to some aspects described herein.

FIG. 9 is a block diagram illustrating an example of a hardware implementation of a scheduling entity employing a processing system according to some aspects of the disclosure.

FIG. 10 is a flow chart illustrating an exemplary process for associating a first plurality of CSI-RS ports with a second plurality of transmission configuration indicator (TCI) states at a scheduling entity in accordance with some aspects of the disclosure.

FIG. 11 is a block diagram illustrating an example of a hardware implementation of a scheduled entity employing a processing system according to some aspects of the disclosure.

FIG. 12 is a flow chart illustrating an exemplary process of wireless communication of a scheduled device (e.g., a scheduled entity) in a wireless communication network in accordance with some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

A channel state information-reference signal (CSI-RS) resource may be configured by a scheduling entity (e.g., a base station) with a predetermined number of CSI-RS ports. According to some examples, there can be up to 32 CSI-RS ports. The ports, sometimes referred to as antenna ports, are logical ports. The logical CSI-RS ports may be mapped to physical antenna elements of an antenna array. According to some examples, the CSI-RS ports may be grouped in one or more code division multiplex (CDM) groups.

The scheduling entity may transmit a CSI-RS resource to a scheduled entity (e.g. a user equipment (UE)). According to some aspects, the CSI-RS resource may be associated with one transmission configuration indicator (TCI) state. However, there may be utility in associating the CSI-RS resource with two (or more) TCI states.

According to some aspects of the disclosure, a scheduled entity may be configured to receive a respective CSI-RS on each of a first plurality of CSI-RS ports from a scheduling entity and may associate the first plurality of CSI-RS ports with a second plurality of transmission configuration indicator (TCI) states. The association may be performed in accordance with a rule that may, for example, be stored in a memory of the scheduled entity and/or the scheduling entity, or that may be transmitted to the scheduled entity by, for example, radio resource control (RRC) signaling. The scheduled entity may then determine a third plurality of pre-coding matrix indicators (PMIs) corresponding to the second plurality of TCI states and transmit the third plurality of precoding matrix indicators (PMIs) corresponding to the second plurality of TCI states, respectively, to the scheduling entity.

Associating the first plurality of CSI-RS ports with a second plurality of transmission configuration indicator (TCI) states, according to a rule, may improve channel quality estimation and determination of PMIs and/or rank indicators (RIs), for example, in use cases that involve scheduled entities that receive signals from multiple transmission reception points (multi-TRPs). For example, a first PMI associated with a first TCI state may be associated with a transmission from a first one of the multi-TRP transmitters, while a second PMI associated with a second TCI state may be associated with a transmission from a second one of the multi-TRP transmitters. As used herein, each TRP may be a collection of antennas.

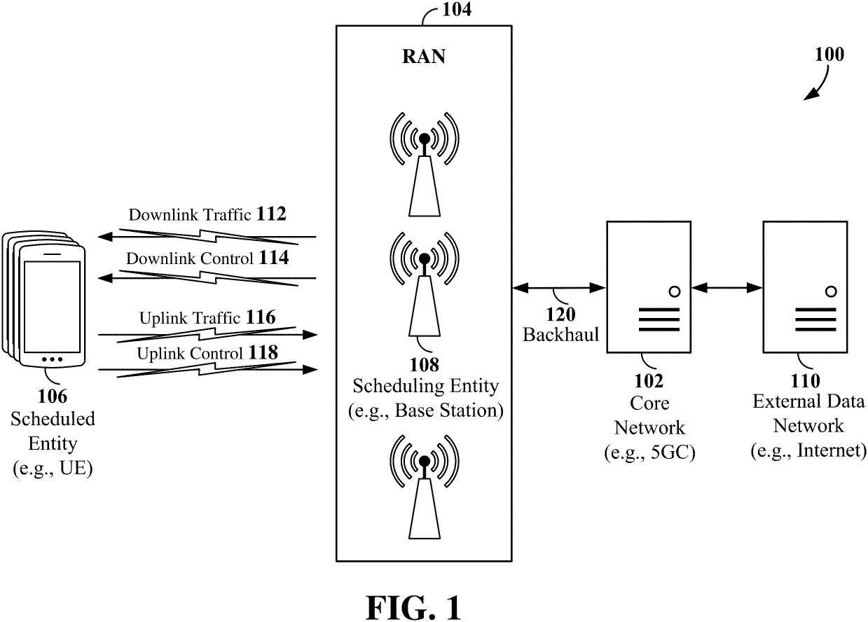

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE 106. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, antenna array modules, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108. A UE 106 that may operate as an unscheduled and/or a scheduled entity may be referred to as a scheduled entity 106 herein.

Base stations, represented in both the singular and the plural by scheduling entity 108, are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106). Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114 (DCI), including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

In general, scheduling entities, as graphically represented in the singular and plural by scheduling entity 108, may include a backhaul interface for communication with a backhaul portion 120 of the wireless communication system 100. The backhaul portion 120 may provide a link between a scheduling entity 108 and the core network 102. Further, in some examples, a backhaul network may provide interconnection between the respective base stations (each similar to scheduling entity 108). Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

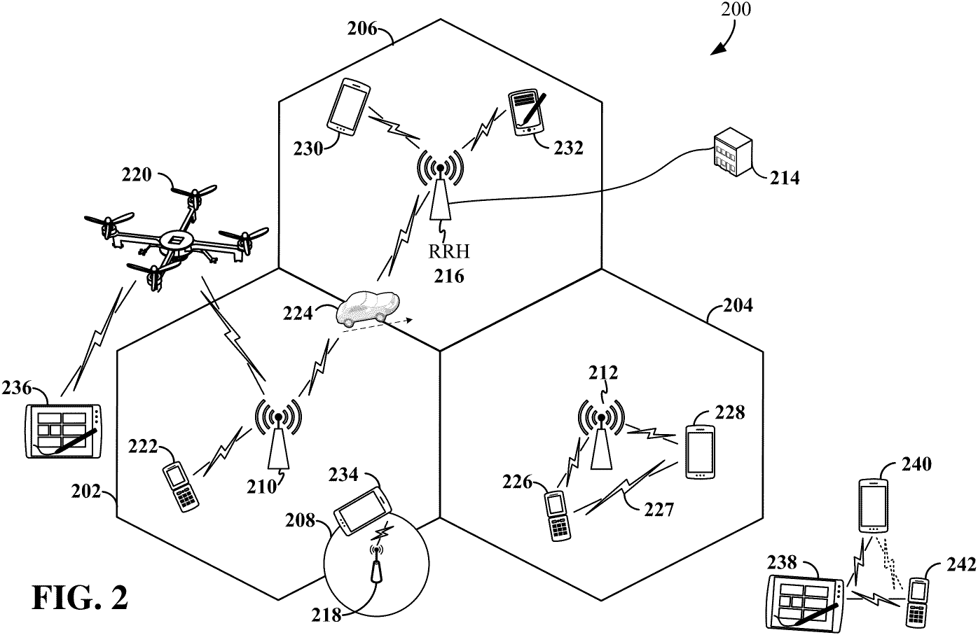

FIG. 2 is a schematic illustration of an example of a radio access network (RAN) 200 according to some aspects of the disclosure. The RAN 200 may implement any suitable wireless communication technology or technologies to provide radio access to a UE, such as UE 222, 224, 226, 228, 230, 232, 234, 236. As one example, the RAN 200 may operate according to 3^{rd} Generation Partnership Project (3GPP) New Radio (NR) specifications, often referred to as 5G. As another example, the RAN 200 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH 216 by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as a quadcopter or drone 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1.

In some examples, a mobile network node (e.g., an unmanned aerial vehicle (UAV) such as a quadcopter or drone 220) may be configured to function as a UE. For example, the quadcopter or drone 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In some examples, the sidelink signals 227 include sidelink traffic and sidelink control. In a further example, UE 238 is illustrated communicating with UEs 240 and 242. Here, the UE 238 may function as a scheduling entity or a primary/transmitting sidelink device, and UEs 240 and 242 may function as a scheduled entity or a non-primary (e.g., secondary/receiving) sidelink device. For example, a UE may function as a scheduling entity or a scheduled entity in a device-to-device (D2D), peer-to-peer (P2P), vehicle-to-vehicle (V2V) network, vehicle-to-everything (V2X), and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P/D2D configuration, or a mesh configuration, a scheduling entity and one or more scheduled entities may communicate utilizing the scheduled resources.

In the RAN 200, the ability for a UE to communicate while moving, independent of its location, is referred to as mobility. The various physical channels between the UE and the RAN 200 are generally set up, maintained, and released under the control of an access and mobility management function (AMF), which may include a security context management function (SCMF) that manages the security context for both the control plane and the user plane functionality and a security anchor function (SEAF) that performs authentication.

In various aspects of the disclosure, a RAN 200 may utilize DL-based mobility or UL-based mobility to enable mobility and handovers (i.e., the transfer of a UE’s connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the network may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

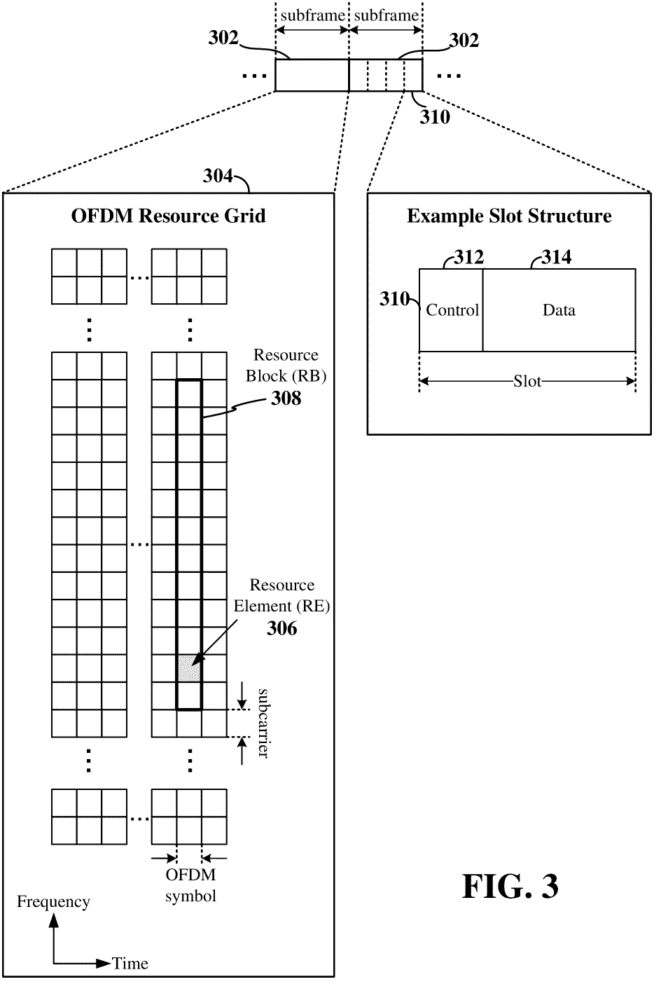

Various aspects of the present disclosure will be described with reference to an OFDM waveform, schematically illustrated in FIG. 3. It should be understood by those of ordinary skill in the art that the various aspects of the present disclosure may be applied to a DFT-s-OFDMA or an SC-FDMA waveform in substantially the same way as described herein below. That is, while some examples of the present disclosure may focus on an OFDM link for clarity, it should be understood that the same principles may be applied as well to DFT-s-OFDMA or SC-FDMA waveforms.

Within the present disclosure, a frame refers to a duration of 10 ms for wireless transmissions, with each frame consisting of 10 subframes of 1 ms each. A transmission burst may include multiple frames. On a given carrier, there may be one set of frames in the UL, and another set of frames in the DL. Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier × 1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs (scheduled entities) for downlink or uplink transmissions typically involves scheduling one or more resource elements 306 within one or more sub-bands or bandwidth parts (BWPs). Thus, a UE generally utilizes only a subset of the resource grid 304. An RB may be the smallest unit of resources that can be allocated to a UE. Thus, the more RBs scheduled for a UE, and the higher the modulation scheme chosen for the air interface, the higher the data rate for the UE.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each subframe 302 (e.g., a 1 ms subframe) may consist of one or multiple adjacent slots. In the illustrative example shown in FIG. 3, one subframe 302 includes four slots 310. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened TTIs may in some cases be transmitted occupying resources scheduled for ongoing slot transmissions for the same or for different UEs. Any number of resource blocks may be utilized within a subframe or slot.

An expanded view of one of the slots 310 illustrates the slot 310 as including a control region 312 and a data region 314. In a first example of the slot 310, the control region 312 may carry control channels (e.g., a physical downlink control channel (PDCCH)) and the data region 314 may carry data channels (e.g., a physical downlink shared channel (PDSCH)). It is understood that the relative positions of the control region 312 and the data region 314 may be reversed. Of course, a slot may contain all DL, all UL, or at least one DL portion and at least one UL portion. The structures illustrated in FIG. 3 are merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals, including but not limited to a demodulation reference signal (DMRS), a control reference signal (CRS), channel state information reference signal (CSI-RS), channel state information-reference signal (CSI-RS), and/or a sounding reference signal (SRS). These pilots or reference signals may provide for a receiving device to perform channel estimation of the corresponding channel, which may enable coherent demodulation/detection of the control and/or data channels within the RB 308.

In some examples, the slot 310 may be utilized for broadcast or unicast communication. For example, a broadcast, multicast, or groupcast communication may refer to a point-to-multipoint transmission by one device (e.g., a base station, UE, or other similar device) to other devices. As used herein, a broadcast communication is delivered to all devices, whereas a multicast communication is delivered to multiple intended recipient devices. A unicast communication may refer to a point-to-point transmission by a one device to a single other device.

In a DL transmission, a transmitting device (e.g., the base station/scheduling entity 108) may allocate one or more REs 306 (e.g., DL REs within the control region 312) to carry DL control information (DCI) including one or more DL control 114 channels that may carry information, for example, originating from higher layers, such as a physical broadcast channel (PBCH), a physical hybrid automatic repeat request (HARQ) indicator channel (PHICH), a physical downlink control channel (PDCCH), etc., to one or more scheduled entities (e.g., UE/scheduled entity 106). A Physical Control Format Indicator Channel (PCFICH) may provide information to assist a receiving device in receiving and decoding the PDCCH and/or Physical HARQ Indicator Channel (PHICH). The PHICH carries HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc. The PDCCH may carry downlink control 114, including downlink control information (DCI) for one or more UEs in a cell. This may include, but not limited to, power control commands, scheduling information, a grant, and/or an assignment of REs for DL and UL transmissions.

The base station may further allocate one or more REs 306 to carry other DL signals, such as a demodulation reference signal (DMRS); a phase-tracking reference signal (PT-RS); a positioning reference signal (PRS), a channel-stated information reference signal (CSI-RS); a primary synchronization signal (PSS); and a secondary synchronization signal (SSS). These DL signals, which may also be referred to as downlink physical signals, may correspond to sets of resource elements used by the physical layer but they generally do not carry information originating from higher layers. A UE may utilize the PSS and SSS to achieve radio frame, subframe, slot, and symbol synchronization in the time domain, identify the center of the channel (system) bandwidth in the frequency domain, and identify the physical cell identity (PCI) of the cell. The synchronization signals PSS and SSS, and in some examples, the PBCH and a PBCH DMRS, may be transmitted in a synchronization signal block (SSB). The PBCH may further include a master information block (MIB) that includes various system information, along with parameters for decoding a system information block (SIB). The SIB may be, for example, a SystemInformationType 1 (SIB1) that may include various additional system information. Examples of system information transmitted in the MIB may include, but are not limited to, a subcarrier spacing, system frame number, a configuration of a PDCCH control resource set (CORESET) (e.g., PDCCH CORESET0), and a search space for SIB1. Examples of additional system information transmitted in the SIB1 may include, but are not limited to, a random access search space, downlink configuration information, and uplink configuration information. The MIB and SIB1 together provide the minimum system information (SI) for initial access.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

In an UL transmission, a transmitting device (e.g., a UE/scheduled entity 106) may utilize one or more REs 306, including one or more UL control 118 channels that may carry uplink control information (UCI) to the base station/scheduling entity 108, for example. UCI may include a variety of packet types and categories, including pilots, reference signals, and information configured to enable or assist in decoding uplink data transmissions. In some examples, the uplink control information may include a scheduling request (SR), i.e., request for the scheduling entity to schedule uplink transmissions. Here, in response to the SR transmitted on the uplink control 118 channel from the scheduled entity 106, the scheduling entity 108 may transmit downlink control information (DCI) that may schedule resources for uplink packet transmissions. UCI may also include HARQ feedback, such as an acknowledgment (ACK) or negative acknowledgment (NACK), channel state information (CSI), channel state feedback (CSF), or any other suitable UL control information (UCI). The UCI may originate from higher layers via one or more UL control channels, such as a physical uplink control channel (PUCCH), a physical random access channel (PRACH), etc. Further, UL REs 306 may carry UL physical signals that generally do not carry information originating from higher layers, such as demodulation reference signals (DMRS), phase-tracking reference signals (PT-RS), sounding reference signals (SRS), etc.

In addition to control information, one or more REs 306 (e.g., within the data region 314) may be allocated for user data traffic. Such traffic may be carried on one or more traffic channels, such as, for a DL transmission, a physical downlink shared channel (PDSCH), or for an UL transmission, a physical uplink shared channel (PUSCH). In some examples, one or more REs 306 within the data region 314 may be configured to carry SIBs (e.g., SIB1), carrying information that may enable access to a given cell.

The physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described herein and illustrated in FIGS. 1-8 are not necessarily all the channels or carriers that may be utilized between a base station/scheduling entity 108 and UEs/scheduled entities 106, and those of ordinary skill in the art will recognize that other channels or carriers may be utilized in addition to those illustrated, such as other traffic, control, and feedback channels.

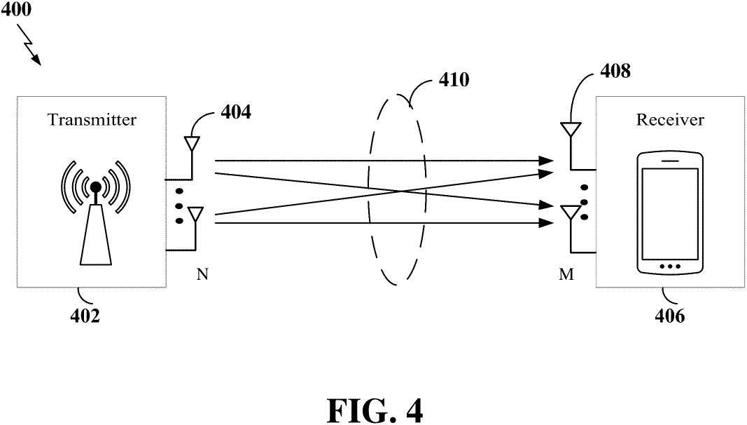

In some aspects of the disclosure, the scheduling entity and/or scheduled entity may be configured for beamforming and/or multiple-input multiple-output (MIMO) technology. FIG. 4 is a block diagram illustrating an example of a wireless communication system 400 supporting beamforming and/or MIMO communication according to some aspects of the disclosure. In a MIMO system, a transmitter 402 includes multiple transmit antennas 404 (e.g., N transmit antennas) and a receiver 406 includes multiple receive antennas 408 (e.g., M receive antennas). Thus, there are N x M signal paths 410 from the transmit antennas 404 to the receive antennas 408. The multiple transmit antennas 404 and multiple receive antennas 408 may each be configured in a single panel or multi-panel antenna array. Each of the transmitter 402 and the receiver 406 may be implemented, for example, within a base station/scheduling entity 108, as illustrated in FIGS. 1 and/or 2, a UE/scheduled entity 106, as illustrated in FIGS. 1 and/or 2, or any other suitable wireless communication device.

The use of such multiple antenna technology enables the wireless communication system 400 to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system (e.g., the wireless communication system 400 supporting MIMO) is limited by the number of transmit or receive antennas 404 or 408, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-plus-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a sounding reference signal (SRS) transmitted from the UE or other pilot signal). Based on the assigned rank, the base station may then transmit a channel state information-reference signal (CSI-RS) with separate CSI-RS sequences for each layer to provide for multi-layer channel estimation. From the CSI-RS, the UE may measure the channel quality across layers and resource blocks and feed back the CQI, PMI, and/or RI values to the base station for use in updating the rank and assigning REs for future downlink transmissions.

In one example, as shown in FIG. 4, a rank-2 spatial multiplexing transmission on a 2x2 MIMO antenna configuration will transmit one data stream from each of the transmit antennas 404. Each data stream reaches each of the receive antennas 408 along a different one of the signal paths 410. The receiver 406 may then reconstruct the data streams using the received signals from each of the receive antennas 408.

Beamforming is a signal processing technique that may be used at the transmitter 402 or receiver 406 to shape or steer an antenna beam (e.g., a transmit/receive beam) along a spatial path between the transmitter 402 and the receiver 406. Beamforming may be achieved by combining the signals communicated via antennas 404 or 408 (e.g., antenna elements of an antenna array) such that some of the signals experience constructive interference while others experience destructive interference. To create the desired constructive/destructive interference, the transmitter 402 or receiver 406 may apply amplitude and/or phase offsets to signals transmitted or received from each of the antennas 404 or 408 associated with the transmitter 402 or receiver 406.

In some examples, to select one or more serving beams for communication with a UE, the base station may transmit a reference signal, such as a synchronization signal block (SSB or SS-block), a tracking reference signal (TRS), or a channel state information reference signal (CSI-RS), on each of a plurality of beams in a beam-sweeping manner. The UE may measure the reference signal received power (RSRP) on each of the beams and transmit a beam measurement report to the base station indicating the Layer 1 (L-1 RSRP) of each of the measured beams. The base station may then select the serving beam(s) for communication with the UE based on the beam measurement report. In other examples, when the channel is reciprocal, the base station may derive the particular beam(s) to communicate with the UE based on uplink measurements of one or more uplink reference signals, such as a sounding reference signal (SRS).

In 5G New Radio (NR) systems, particularly for above 6 GHz or millimeter wave (mmWave) systems, beamformed signals may be utilized for downlink channels, including the physical downlink control channel (PDCCH) and physical downlink shared channel (PDSCH). In addition, for UEs configured with beamforming antenna array modules, beamformed signals may also be utilized for uplink channels, including the physical uplink control channel (PUCCH) and the physical uplink shared channel (PUSCH). However, it should be understood that beamformed signals may also be utilized by, for example, enhanced mobile broadband (eMBB) gNBs for sub 6 GHz systems.

Beamforming may be used in both half duplex and full duplex wireless communication networks. In full duplex networks, downlink and uplink transmissions may occur simultaneously. In some examples, full duplex networks may utilize sub-band FDD in unpaired spectrum, in which transmissions in different directions are carried in different sub-bands or BWPs of the carrier bandwidth.

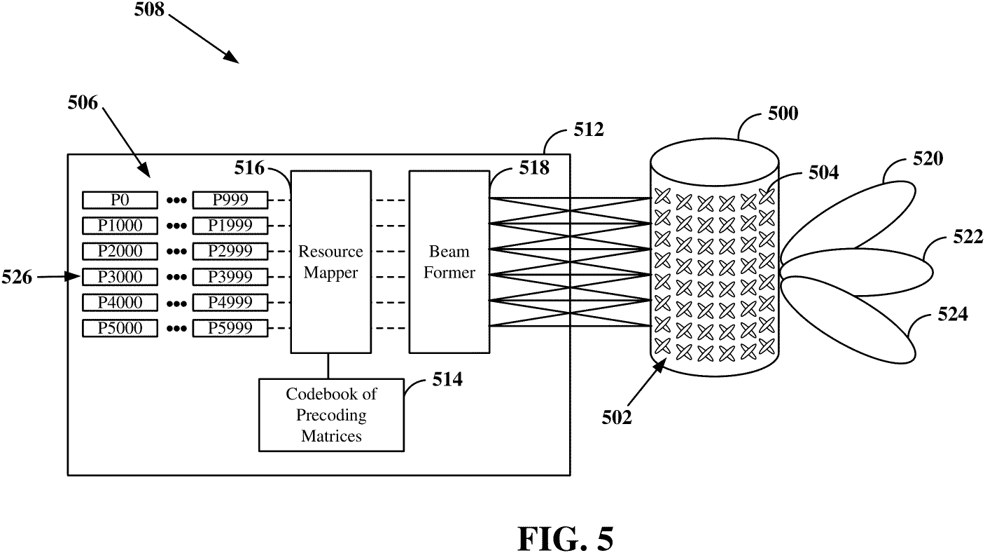

FIG. 5 is a schematic illustration demonstrating physical layer (e.g., L1) mapping of logical antenna ports to physical antenna elements according to some aspects of the disclosure. Antenna arrays, which are graphically represented by antenna array 500, may be formed of a plurality of antenna elements 502.

The antenna array 500 may be configured as a single panel or a multi-panel antenna array. Each panel includes a portion of the plurality of antenna elements 502. The term “antenna element” may refer to a pair of cross-polarized antenna elements 504. Each of the antenna elements 504 is a physical structure. The term “antenna port” is a logical port related to the physical layer (L1). Antenna ports 506 are graphically depicted by the plurality of antenna port numbers in FIG. 5. Antenna ports 506 may be mapped to antenna elements 502 for generation of antenna beams. According to one example, an antenna array, similar to the antenna array 500 of FIG. 5, may include 128 pairs of cross polarized antenna elements (e.g., 256 total antenna elements in a 16x8 array) that may be mapped to 32 antenna ports by an 8x1 combiner.

In an example of a scheduling entity 508, antenna ports 506 that may be defined for the uplink include, for example, antenna ports starting with port number 0 for DMRS for PUSCH, antenna ports starting with port number 1000 for SRS for PUSCH, antenna ports starting with port number 2000 for PUCCH, and antenna ports starting with port number 4000 for PRACH. Antenna ports 506 that may be defined for the downlink include, for example, antenna ports starting with port number 1000 for PDSCH, antenna ports starting with port number 2000 for PDCCH, antenna ports starting with port number 3000 for CSI-RS, antenna ports starting with port number 4000 for SS-block/PBCH transmission, and antenna ports starting with port number 5000 for positioning reference signals (PRS).

For MIMO transmissions, each layer (or data stream) may be mapped to one of the logical antenna ports, which may be spread across one or more physical antenna elements for transmission or reception thereof. In an example, as mentioned above, the antenna array 500 including one or more antenna panels may include 128 pairs of cross-polarized antenna elements mapped to 32 antenna ports by an 8x1 combiner. The antenna elements 504 may be divided into a plurality of panels (not shown). Two adjacent antenna panels may or may not have a physical separation or pronounced gap therebetween.

The scheduling entity 508, represented in part by the various circuits, modules, and/or functions 512 and the antenna array 500, may maintain a codebook of precoding matrices 514 and map the different transmission layers to the set of antenna ports 506 of the scheduling entity 508 using a selected precoding matrix. The precoding matrix provides the appropriate weightings to be applied to each layer for generation of the respective beam for each layer. The precoding matrix may be selected based on the PMI received (e.g., fed back) from the scheduled entity (not shown) to the scheduling entity 508 in, for example, a channel state information (CSI) report. For example, using the PMI, the scheduling entity may select a particular precoding matrix from the codebook of precoding matrices 514 for a MIMO transmission.

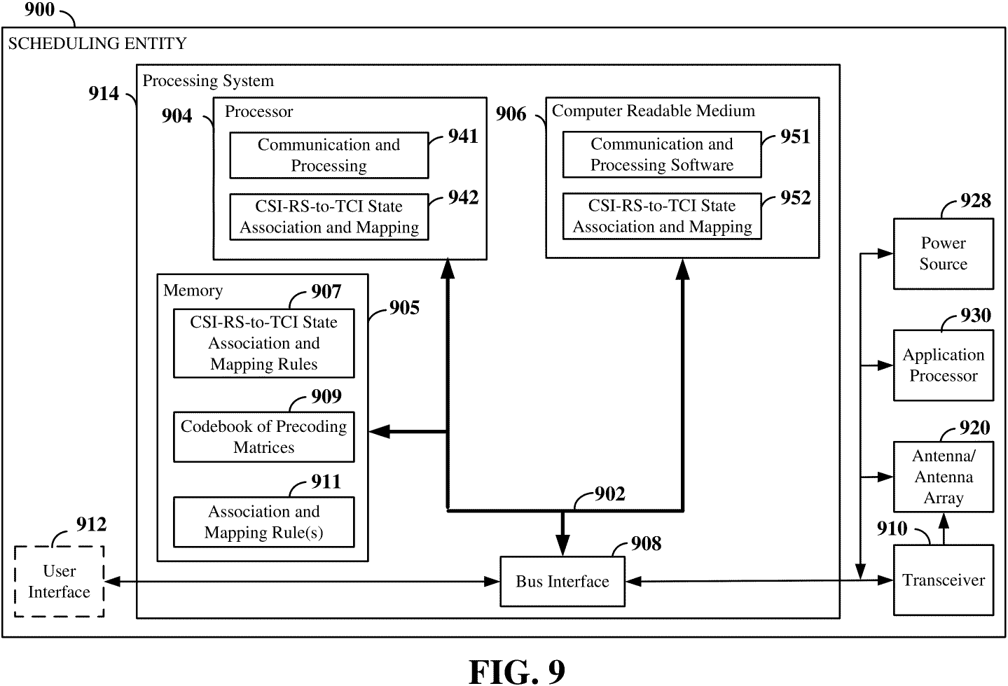

The logical antenna ports 506, numbered PO-P5999, may be referred to collectively as antenna ports 506. The antenna ports 506 may be applied to a resource mapper 516. The resource mapper 516 may obtain a precoding matrix from the codebook of precoding matrices 514. The resource mapper 516 may be implemented in hardware and/or software and may be described as a circuit, a module, and/or a function. The codebook of precoding matrices 514 may be stored in a memory (e.g., similar to memory 905 of FIG. 9) of the scheduling entity 508. Following the mapping of antenna ports 506 to resources by the resource mapper 516, the resource mapped antenna ports 506 may be applied to a beam former 518. The beam former 518 may be implemented in hardware and/or software and may be described as a circuit, a module, and/or a function. The beam former 518 may match the resource mapped antenna ports 506 to the plurality of physical antenna elements 502 of the antenna array 500.

Each physical antenna element 504 of the plurality of the plurality of physical antenna elements 502 may include a pair of cross-polarized physical antenna elements (graphically represented by crossed ellipsoids). The antenna array 500 may form one or more antenna beams, such as first antenna beam 520, second antenna beam 522, and third antenna beam 524 based on the output of the beam former 518.

Antenna beams may be formed from various mappings of the logical antenna ports 506 to the plurality of physical antenna elements 502. The mapping of antenna ports 506 to physical antenna elements 502 may be one-to-one and/or one-to many. An antenna port may be defined such that a channel over which a symbol on the antenna port is conveyed can be inferred from the channel over which another symbol on the same antenna port is conveyed. A scheduled entity may assume that two transmitted signals have experienced the same radio channel if they are transmitted from the same one or more antenna ports. Individual downlink transmissions may be carried out from a specific one or more antenna ports, the identity of which are known to the scheduled entity. For example, the scheduling entity 508 may transmit a respective CSI-RS on a downlink to the scheduled entity on any of a first plurality of CSI-RS antenna ports, identified as CSI-RS ports 526 (identified by port numbers P3000-P3999) of FIG. 5.

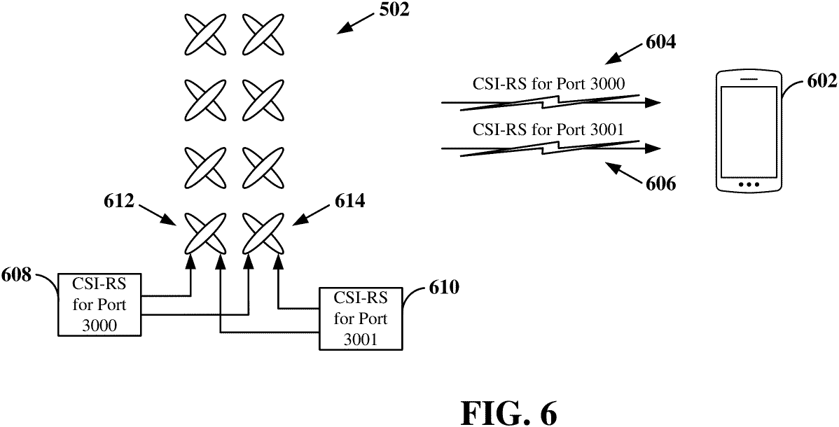

FIG. 6 is a schematic diagram illustrating a portion of the plurality of physical antenna elements 502 of the antenna array 500 of FIG. 5, and a scheduled entity 602, according to some aspects of the disclosure. A first CSI-RS 604 transmitted on a first CSI-RS resource corresponding to a first CSI-RS port 608 (represented by CSI-RS port number 3000) and the second CSI-RS 606 transmitted on a second CSI-RS resource corresponding to a second CSI-RS port 610 (represented by CSI-RS port number 3001) may be received by the scheduled entity 602. Of course, the CSI-RS resource for each CSI-RS 604 and 606 may include a plurality of CSI-RS ports; however, in the example of FIG. 6, each CSI-RS resource includes one respective CSI-RS port for simplicity.

In the example of FIG. 6, the first CSI-RS port 608 and the second CSI_RS port 610 are mapped onto first physical antenna element 612 and second physical antenna element 614. The one-to-many mapping provides beamforming. The scheduled entity 602 may receive the first CSI-RS 604 and the second CSI-RS 606 corresponding to the first CSI-RS port 608 and the second CSI_RS port 610, respectively.

The scheduled entity 602 may use the received first CSI-RS 604 and the second CSI-RS 606 to estimate channel quality and to determine, for example, PMI and/or RI, or joint PMI and/or joint RI, on a per CSI-RS port basis and/or on per-code division multiplex (CDM) group basis. For example, the scheduled entity 602 may measure the SINR of each received CSI-RS and generate a CSI report for each channel. Each CSI report may include a respective set of CSI report values. For example, each CSI report may include a respective channel quality indicator (CQI), rank indicator (RI), precoding matrix indicator (PMI), and/or layer indicator (LI). Here, the LI indicates which column of a precoding matrix of the reported PMI corresponds to the strongest layer codeword corresponding to the largest reported wideband CQI. In some examples, each CSI report may further include the L1-RSRP of each of the measured transmit (DL) beams. The scheduling entity may use the CSI reports to update the rank associated with the scheduled entity, select serving DL beam(s) for communication with the scheduled entity, and assign resources (e.g., based on a modulation and coding scheme (MCS)) for future transmissions to the scheduled entity 602.

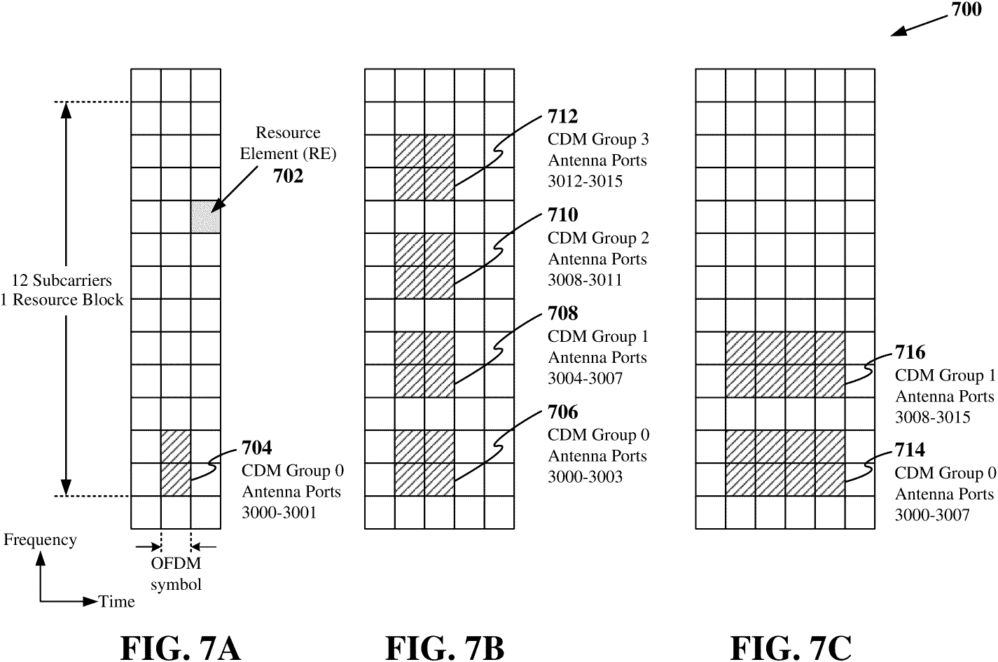

FIGS. 7A, 7B, and 7C are schematic illustrations of an organization of resource elements 700 (in a time-frequency resource grid) in an air interface utilizing orthogonal frequency divisional multiplexing (OFDM) according to some aspects of the disclosure. In FIGS. 7A, 7B, and 7C, frequency is shown in the vertical direction in units of subcarriers and/or resource elements (REs) and time is shown in the horizontal direction in units of OFDM symbols. There may be 12 subcarriers per one resource block (RB), as illustrated in the exemplary schematic illustrations of FIGS. 7A, 7B, and 7C.

REs 702 may be grouped by antenna port (e.g., by antenna port number). Antenna port groups may be grouped as code division multiplex (CDM) groups 704-718. There may be one or more CDM groups 704-718 that may each include one or more antenna ports. Each of the CDM groups 704-718 may include consecutive REs 702 in frequency and time.

There may be, for example, a first CDM group 704 with 2 REs in frequency and 1 RE (OFDM symbol) in time as shown in FIG. 7A. That is, there may be two antenna ports in adjacent REs in frequency. The two antenna ports in adjacent REs in frequency may be code division multiplexed (CDMed) together, forming the first CDM group 704 of FIG. 7A.

There may be, for example, a second CDM group 706 with four REs in total. CDM groups 708-712 are additional examples of CDM groups each with four REs in total. The REs between adjacent CDM groups in FIG. 7B are included for illustrative purpose. As illustrated, each CDM group may include two REs in frequency and two REs (OFDM symbols) in time as shown in FIG. 7B. That is, there may be four antenna ports (e.g., antenna ports 3000-3003 in the second CDM group 706) in adjacent REs in frequency and time. The four antenna ports may be code division multiplexed (CDMed) together, forming the second CDM group 706 and each of the other three CDM groups 708-712 of FIG. 7B.

There may be, for example, a third CDM group 714 with eight REs in total. A fourth CDM group 716 is an additional example of a CDM group with eight REs in total. The REs between adjacent CDM groups in FIG. 7B are included for illustrative purpose. As illustrated, each CDM group may include two REs in frequency and 4 REs (OFDM symbols) in time as shown in FIG. 7C. That is, there may be eight antenna ports (e.g., antenna ports 3000-3007 in the third CDM group 714) in adjacent REs in frequency and time. The eight antenna ports may be code division multiplexed (CDMed) together, forming the third CDM group 714 and the fourth CDM group 716 of FIG. 7C. In general, for a quantity of P ports, the PMI may correspond to CSI-RS antenna ports numbered from 3000 to 3000+P-1 on a per CSI-RS port basis or on a per CDM group basis, for example.

All antenna ports within a CSI-RS resource may be considered to be quasi-co-located (QCLed). Two antenna ports are said to be QCLed if properties of the channel over which a symbol on one antenna port is conveyed can be inferred from the channel over which a symbol on the other antenna port is conveyed. As described above, a scheduled entity may receive each CSI-RS resource in a downlink from a scheduling entity as shown in FIG. 6, for example. The scheduled entity may report a precoding matrix indicator (PMI) back to the scheduling entity in response to receiving the CSI-RS resources.

Various aspects of the disclosure may provide for a scheduling entity to be configured to allow a scheduled entity to transmit pre-coding matrix indicators (PMIs), that may correspond to multiple TCI states, to the scheduling entity. This may be useful, for example, for multi-transmission reception point (multi-TRP) transmission. For example, a scheduling entity may configure multiple (e.g., two) TCI states to be associated with a plurality of CSI-RS ports in the same CSI-RS resource. Using the multiple of two as an exemplary and non-limiting number, the scheduling entity (or scheduled entity), in accordance with a fixed rule stored at the scheduling entity and/or the scheduled entity, or in a configuration sent from the scheduled entity to the scheduling entity (for example through RRC signaling), the scheduled/scheduling entity may divide the total number of CSI-RS ports of the CSI-RS resource into two CSI-RS port groups. CSI-RS ports in the first CSI-RS port group may have a first TCI state (e.g., corresponding to a first TRP). CSI-RS ports in the second CSI-RS port group may have a second TCI state (e.g., corresponding to a second TRP). The size of each group may or may not be equal. In examples described herein, the association of CSI-RS ports to TCI states may be on a per CSI-RS port basis or may be on a per CMD group basis.

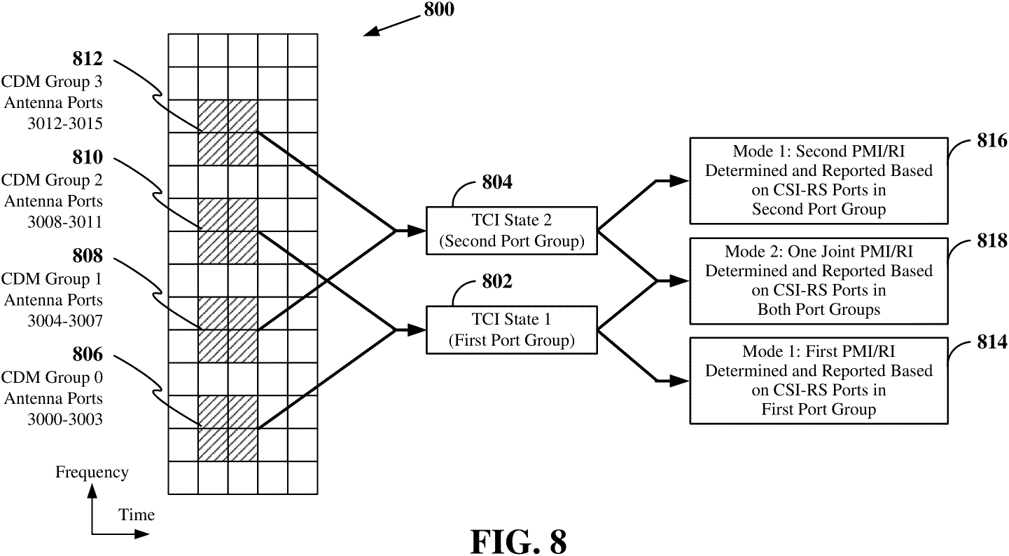

FIG. 8 is a schematic diagram illustrating relationships between an organization of resource elements 800, CSI-RS ports, CDM groups, TCI states, and reporting modes according to some aspects described herein. In FIG. 8, frequency is shown in the vertical direction in units of subcarriers and/or resource elements (REs) and time is shown in the horizontal direction in units of OFDM symbols. Similar to FIG. 7B, there may be, for example, four CDM groups with four CSI-RS ports in each CDM group: CDM group 0 806 (with CSI-RS ports 3000-3003); CDM group 1 808 (with CSI-RS ports 3004-3007); CDM group 2 820 (with CSI-RS ports 3008-3022); and CDM group 3 812 (with CSI-RS ports 3012-3015). In the example of FIG. 8, the CSI-RS resource includes all 16 CSI-RS ports (3000-3015). The CSI resource may be configured with two TCI states: TCI state 1 802, which may constitute a first port group; and TCI state 2 804, which may constitute a second port group. On a per CSI-RS port basis, CSI-RS ports 3000-3003 and 3008-3011 are associated with TCI state 1 802, while CSI-RS ports 3004-3007 and 3012-3015 are associated with TCI state 2 804. On a per CDM group basis, CDM group 0 806 and CDM group 2 810 are associated with TCI state 1 802, while CDM group 1 808 and CDM group 3 812 are associated with TCI state 2 804.

PMI and/or RI may be determined and reported, for example, in two modes. A first mode, which may be referred to as Mode 1 814, 816 may be a non-coherent joint transmission mode, in which a scheduled entity may determine and report two PMIs corresponding to the CRS-RS ports in the first port group and the second port group, respectively. Each port group corresponds to a respective TCI state. For example, in Mode 1, a first PMI 814 associated with TCI state 1 802 may be determined and reported based on the CSI-RS ports in the first port group (CSI-RS ports 3000-3003 and 3008-3011), while a second PMI 816 associated with TCI state 2 804 may be determined and reported based on the CSI-RS ports in the second port group (CSI-RS ports 3004-3007 and 3012-3015). The scheduled entity may also determine and report two separate RIs, corresponding to the two PMIs.

A second mode, which may be referred to as Mode 2, may be a coherent joint transmission, in which a scheduled entity may determine and report one joint PMI corresponding to all CSI-RS ports jointly included in the first port group and the second port group (which are associated with both TCI states). For example, in Mode 2, one joint PMI 818 associated with both TCI states 802, 804 may be determined and reported based on all of the CSI-RS ports in both port groups (CSI-RS ports 3000-3015). The scheduled entity may also determine and report one joint RI, corresponding to the one joint PMI.

FIG. 9 is a block diagram illustrating an example of a hardware implementation for a scheduling entity 900 (e.g., a base station) employing a processing system 914 according to some aspects of the disclosure. The scheduling entity 900 may be, for example, a base station, an eNB, a gNB, or a network access node as illustrated in any one or more of FIGS. 1, 2, 4, 5, and/or 6.

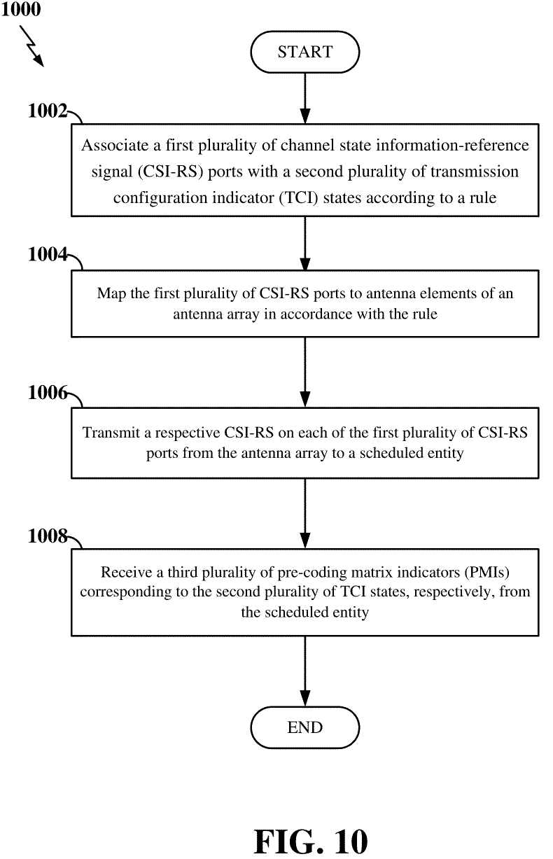

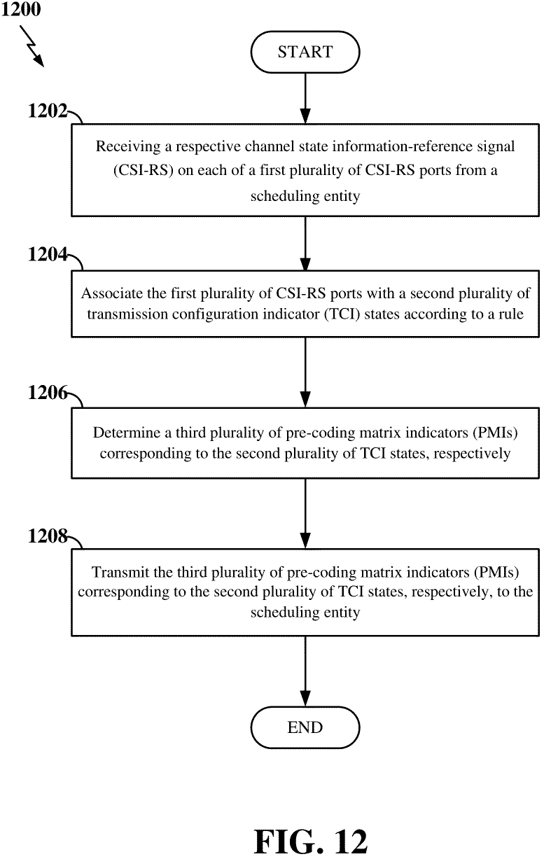

In accordance with various aspects of the disclosure, an element, or any portion of an element, or any combination of elements may be implemented with a processing system 914 that includes one or more processors, such as processor 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 900 may be configured to perform any one or more of the functions described herein. That is, the processor 904, as utilized in the scheduling entity 900, may be used to implement any one or more of the methods or processes described and illustrated, for example, in FIG. 10 and/or FIG. 12.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further.

A bus interface 908 provides an interface between the bus 902 and a transceiver 910 (e.g., a wireless transceiver). The transceiver 910 provides a means for communicating with various other apparatus over a transmission medium (e.g., air interface). The transceiver 910 may further be coupled to one or more antennas/antenna array/antenna module (hereinafter antenna array 920). The bus interface 908 further provides an interface between the bus 902 and a user interface 912 (e.g., keypad, display, touch screen, speaker, microphone, control features, etc.). Of course, such a user interface 912 is optional, and may be omitted in some examples. In addition, the bus interface 908 further provides an interface between the bus 902 and a power source 928, and between the bus 902 and an application processor 930, which may be separate from a modem (not shown) of the scheduling entity 900 or processing system 914.

One or more processors, such as processor 904, may be responsible for managing the bus 902 and general processing, including the execution of software stored on the computer-readable medium 906. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 906. The software, when executed by the processor 904, causes the processing system 914 to perform the various processes and functions described herein for any particular apparatus.

The computer-readable medium 906 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product or article of manufacture. By way of example, a computer program product or article of manufacture may include a computer-readable medium in packaging materials. In some examples, the computer-readable medium 906 may be part of the memory 905. The memory 905 may store, for example, CSI-RS-to-TCI state association rules 907 and/or one or more codebook(s) of precoding matrices 909 according to some aspects of the disclosure. Those skilled in the art will recognize how best to implement the described functionality presented throughout this disclosure depending on the particular application and the overall design constraints imposed on the overall system. The computer-readable medium 906 and/or the memory 905 may also be used for storing data that is manipulated by the processor 904 when executing software.

In some aspects of the disclosure, the processor 904 may include communication and processing circuitry 941 configured for various functions, including for example communicating with a scheduled entity (e.g., a UE, a wireless communication device), a network core (e.g., a 5G core network), other scheduling entities, or any other entity, such as, for example, local infrastructure or an entity communicating with the scheduling entity 900 via the Internet, such as a network provider. In some examples, the communication and processing circuitry 941 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 941 may be configured to receive and process uplink traffic and uplink control messages (e.g., similar to uplink traffic 116 and uplink control 118 of FIG. 1) and process and transmit downlink traffic and downlink control messages (e.g., similar to downlink traffic 112 and downlink control 114) via the antenna array 920 and the transceiver 910. In addition, the communication and processing circuitry 941 may be configured to transmit a respective CSI-RS on each of a first plurality of CSI-RS ports from an antenna array 920 to a scheduled entity and receive, in response from the scheduled entity, a third plurality of pre-coding matrix indicators (PMIs) corresponding to a second plurality of TCI states, respectively, with or without a sixth plurality of RIs corresponding to the third plurality of PMIs, respectively, and/or a joint PMI corresponding to the second plurality of TCI states, collectively, with or without a joint RI corresponding to the joint PMI. The communication and processing circuitry 941 may further be configured to execute communication and processing software 951 stored on the computer-readable medium 906 to implement one or more functions described herein.

In some aspects of the disclosure, the processor 904 may include channel state information-reference signal (CSI-RS) -to- transmission configuration indicator (TCI) state (CSI-RS-to-TCI state) association and mapping circuitry 942 configured for various functions, including, for example, associating a first plurality of CSI-RS ports with a second plurality of transmission configuration indicator (TCI) states according to a rule, and mapping the first plurality of CSI-RS ports to antenna elements of an antenna array 920 in accordance with the rule. In some examples, the CSI-RS association and mapping circuitry 942 may include one or more hardware components that provide the physical structure that performs processes related to performing the associating of the first plurality of CSI-RS ports with the second plurality of TCI states according to the rule and mapping the first plurality of CSI-RS ports to antenna elements of an antenna array 920 in accordance with the rule. The rule may be an association and mapping rule(s) 911 that may be stored, for example, in the memory 905. The CSI-RS-to-TCI state association and mapping circuitry 942 may further be configured to execute CSI-RS-to-TCI state association and mapping software 952 stored on the computer-readable medium 906 to implement one or more functions described herein.

FIG. 10 is a flow chart illustrating an exemplary process 1000 (e.g., a method) for associating a first plurality of CSI-RS ports with a second plurality of TCI states at a scheduling entity (e.g., a base station, a network access node) in accordance with some aspects of the disclosure. As described below, some or all illustrated features may be omitted in a particular implementation within the scope of the present disclosure, and some illustrated features may not be required for implementation of all embodiments. In some examples, the process 1000 may be carried out by the scheduling entity 900 illustrated in FIG. 9. In some examples, the process 1000 may be carried out by any suitable apparatus or means for carrying out the functions or algorithms described herein.

At block 1002, the scheduling entity may associate a first plurality of channel state information-reference signal (CSI-RS) ports with a second plurality of transmission configuration indicator (TCI) states. The association may be performed according to a rule. The rule may be stored at a memory (e.g. 905) of the scheduling entity or may otherwise be obtained by the scheduling entity. The rule may be a fixed rule or a configurable rule. In some examples, associating the first plurality of CSI-RS ports with the second plurality of TCI states may be performed on a per-CSI-RS port basis. In other examples, associating the first plurality of CSI-RS ports with the second plurality of TCI states may be performed on a per-code division multiplex (CDM) group basis.

At block 1004, the scheduling entity may map the first plurality of CSI-RS ports to antenna elements of an antenna array in accordance with the rule.

At block 1006, the scheduling entity may transmit a respective CSI-RS on each of the first plurality of CSI-RS ports from the antenna array to a scheduled entity.

At block 1008, the scheduling entity may receive a third plurality of pre-coding matrix indicators (PMIs) corresponding to the second plurality of TCI states, respectively, from the scheduled entity.

For example, when the rule is a fixed rule, the associating the first plurality of CSI-RS ports with the second plurality of TCI states may include associating each of a fourth plurality of sets of CSI-RS ports with a respective one of the second plurality of TCI states. In some examples, each of the fourth plurality of sets of CSI-RS ports may include a series of contiguous CSI-RS ports selected from the first plurality of CSI-RS ports. In some examples, each of the fourth plurality of sets of CSI-RS ports may include any two or more CSI-RS ports selected from the first plurality of CSI-RS ports. The first of the fourth plurality of sets of CSI-RS ports may begin with a lowest numbered CSI-RS port and a last of the fourth plurality of sets of CSI-RS ports may end with a highest numbered CSI-RS port, both of the first plurality of CSI-RS ports.

For example, when the rule is a configured rule, the scheduling entity may further associate the first plurality of CSI-RS ports with respective ones of the second plurality of TCI states. In another example, the scheduling entity may associate a greater number of the first plurality of CSI-RS ports with one of the second plurality of TCI states relative to any other one of the second plurality of TCI states. When the rule is a configured rule, the scheduling entity may set the configured rule in the scheduled entity through radio resource control (RRC) signaling.

In some examples, when associating the first plurality of CSI-RS ports with the second plurality of TCI states is performed on a per-code division multiplex (CDM) group basis, the first plurality of CSI-RS ports may be divided into a fifth plurality of CDM groups. According to some aspects, all CSI-RS ports associated with a given one of the fifth plurality of CDM groups may be associated with one of the second plurality of TCI states.

In some examples, when associating the first plurality of CSI-RS ports with the second plurality of TCI states is performed on the per-code division multiplex (CDM) group basis, and the rule is a fixed rule, the scheduling entity may associate each of the fifth plurality of CDM groups with a respective one of the second plurality of TCI states. In some examples, each of the fifth plurality of CDM groups may include a series of contiguous set of CSI-RS ports selected from the first plurality of CSI-RS ports. In other examples, each of the fifth plurality of CDM groups may include any two or more CSI-RS ports selected from the first plurality of CSI-RS ports. According to some aspects, a first of the fifth plurality of CDM groups may begin with a lowest numbered CSI-RS port and a last of the fifth plurality of CDM groups may end with a highest numbered CSI-RS port, both of the first plurality of CSI-RS ports.

In other examples, when the rule is a configured rule the scheduling entity may associate the fifth plurality of CDM groups with respective ones of the second plurality of TCI states. The scheduling entity may set the configured rule in the scheduled entity through radio resource control (RRC) signaling. In still other examples, when the rule is a configured rule the scheduling entity may associate a greater number of the fifth plurality of CDM groups with one of the second plurality of TCI states relative to any other one of the second plurality of TCI states. In these still other examples, the scheduling entity may also set the configured rule in the scheduled entity through radio resource control (RRC) signaling.

In accordance with some aspects, the first plurality of CSI-RS ports may be numbered as a function of CDM group number. In such aspects, two or more of the fifth plurality of CDM groups may be associated with a first of the second plurality of TCI states, and the scheduling entity may number the CSI-RS ports of the two or more of the fifth plurality of CDM groups that are associated with the first of the second plurality of TCI states with a first contiguous series of CSI-RS port numbers, and may number the CSI-RS ports associated with a second of the second plurality of TCI states with a second contiguous series of CSI-RS port numbers, where the second contiguous series of CSI-RS port numbers may be different from the first contiguous series of CSI-RS port numbers. According to one aspect, the first contiguous series of CSI-RS port numbers and the second contiguous series of CSI-RS port numbers may be integers, and the integers of the first contiguous series may come before the integers of the second contiguous series.

According to some aspects, the scheduling entity, when configured to perform associations between a first plurality of CSI-RS ports with a second plurality of TCI states on a per-CSI-RS port basis or on a per CDM group basis, may further receive a sixth plurality of rank indicators (RIs) corresponding to the third plurality of PMIs, respectively, from the scheduled entity. In some examples, the scheduling entity may additionally configure the scheduled entity to transmit either: the third plurality of PMIs and the sixth plurality of RIs, or a joint PMI corresponding to the second plurality of TCI states, collectively, and a joint rank indicator (RI) corresponding to the joint PMI to the scheduling entity, in accordance with an instruction received from the scheduled entity. The instruction may be sent through radio resource control (RRC) signaling.

In some examples, In other aspects, when configured to perform associations between a first plurality of CSI-RS ports with a second plurality of TCI states on a per-CSI-RS port basis or on a per CDM group basis, the scheduling entity may further receive, in addition to the third plurality of PMIs or as an alternative to the third plurality of PMIs, a joint PMI corresponding to the second plurality of TCI states, collectively, from the scheduled entity. In accordance with such an aspect, the scheduling entity may also receive a joint rank indicator (RI) corresponding to the joint PMI, from the scheduled entity.

In one configuration, the scheduling entity 900 for wireless communication includes means for associating a first plurality of channel state information-reference signal (CSI-RS) ports with a second plurality of transmission configuration indicator (TCI) states according to a rule, means for mapping the first plurality of CSI-RS ports on each of the first plurality of CSI-RS ports from the antenna array to a scheduled entity, means for transmitting a respective CSI-RS on each of the first plurality of CSI-RS ports from the antenna array to a scheduled entity, and means for receiving a third plurality of pre-coding matrix indicators (PMIs) corresponding to the second plurality of TCI states, respectively, from the scheduled entity. In one aspect, the aforementioned means may be the processor 904 shown in FIG. 9 and configured to perform the functions recited by the aforementioned means. In another aspect, the aforementioned means may be a circuit, or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable medium 906, or any other suitable apparatus or means described in any one of the FIGS. 1, 2, 4, 5, 6, 9, and/or 11 and utilizing, for example, the processes and/or algorithms described herein in relation to FIG. 10.

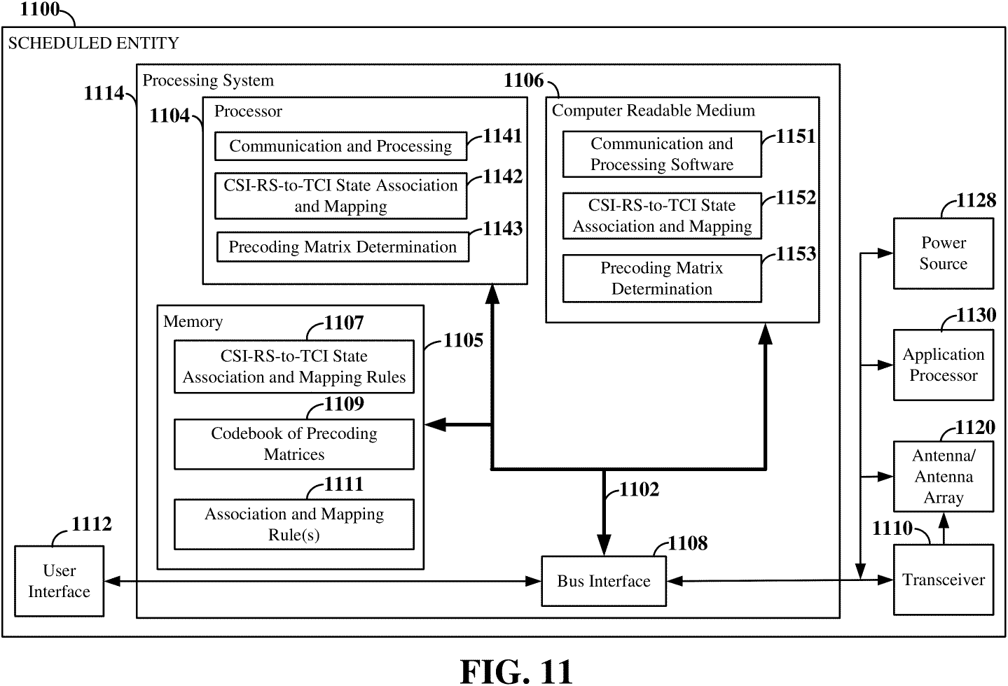

FIG. 11 is a block diagram illustrating an example of a hardware implementation of scheduled entity 1100 employing a processing system 1114 according to some aspects of the disclosure. For example, the scheduled entity 1100 may be a user equipment (UE) or wireless communication device as illustrated in any one or more of FIGS. 1, 2, 3, 4, 5, and/or 6.

The processing system 1114 may be substantially the same as the processing system 914 illustrated in FIG. 9, including a bus interface 1108, a bus 1102, memory 1105, a processor 1104, and a computer-readable medium 1106. IN the example of FIG. 11, the memory 1105 may store, for example, CSI-RS-to-TCI state association rules 1107 and/or one or more codebook(s) of precoding matrices 1109 according to some aspects of the disclosure. In accordance with various aspects of the disclosure, an element, or any portion of an element, or any combination of elements may be implemented with a processing system 1114 that includes one or more processors, such as processor 1104. Furthermore, the scheduled entity 1100 may include a user interface 1112, a transceiver 1110 (e.g., a wireless transceiver), an antenna/antenna array/antenna module 1120, an application processor 1130, and a power source 1128 substantially similar to those described above in FIG. 9. That is, the processor 1104, as utilized in a scheduled entity 1100, may be used to implement any one or more of the processes described herein and illustrated, for example, in FIG. 12.

In some aspects of the disclosure, the processor 1104 may include communication and processing circuitry 1141 configured for various functions, including for example communicating with a network core (e.g., a 5G core network), other scheduled entities, or any other entity, such as, for example, local infrastructure or an entity communicating with the scheduled entity 1100 via the Internet, such as a network provider. In some examples, the communication and processing circuitry 1141 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 1141 may be configured to receive and process downlink traffic and downlink control (e.g., similar to downlink traffic 112 and downlink control 114 of FIG. 1) and process and transmit uplink traffic and uplink control (e.g., similar to uplink traffic 116 and uplink control 118). In addition, the communication and processing circuitry 1141 may be configured to receive a respective channel state information-reference signal (CSI-RS) on each of a first plurality of CSI-RS ports from a scheduling entity and transmitting a third plurality of pre-coding matrix indicators (PMIs) corresponding to the second plurality of TCI states, respectively, to the scheduling entity. The communication and processing circuitry 1141 may further be configured to execute communication and processing software 1151 stored on the computer-readable medium 906 to implement one or more functions described herein.

In some aspects of the disclosure, the processor 1104 may include CSI-RS-to-TCI state association and mapping circuitry 1142 configured for various functions, including, for example, associating the first plurality of CSI-RS ports with a second plurality of transmission configuration indicator (TCI) states according to a rule. The rule may be an association and mapping rule(s) 1111 that may be stored, for example, in the memory 1105. In some examples, the CSI-RS-to-TCI state association and mapping circuitry 1142 may include one or more hardware components that provide the physical structure that performs processes related to performing the association of the first plurality of CSI-RS ports with the second plurality of transmission configuration indicator (TCI) states according to a rule. The CSI-RS-to-TCI state association and mapping circuitry 1142 may further be configured to execute CSI-RS-to-TCI state association and mapping software 1152 stored on the computer-readable medium 1106 to implement one or more functions described herein.

In some aspects of the disclosure, the processor 1104 may include precoding matrix determination circuitry 1143 configured for various functions, including, for example, determining a third plurality of pre-coding matrix indicators (PMIs) corresponding to the second plurality of TCI states, respectively. In some examples, the precoding matrix determination circuitry 1143 may include one or more hardware components that provide the physical structure that performs processes related to performing the determination of the third plurality of PMIs corresponding to the second plurality of TCI states, respectively. The precoding matrix determination circuitry 1143 may further be configured to execute precoding matrix determination software 1153 stored on the computer-readable medium 1106 to implement one or more functions described herein.

In some aspects of the disclosure, the processor 1104 may include precoding matrix determination circuitry 1144 configured for various functions, including, for example, determining a third plurality of pre-coding matrix indicators (PMIs) corresponding to the second plurality of TCI states, respectively. In some examples, the precoding matrix determination circuitry 1144 may include one or more hardware components that provide the physical structure that performs processes related to performing the determination of the third plurality of pre-coding matrix indicators (PMIs) corresponding to the second plurality of TCI states, respectively. The precoding matrix determination circuitry 1143 may determine or otherwise obtain the precoding matrix from the codebook of precoding matrices 1109 that may be stored in the memory 1105 of the scheduled entity 1100. The precoding matrix determination circuitry 1144 may further be configured to execute precoding matrix determination software 1154 stored on the computer-readable medium 1106 to implement one or more functions described herein.

FIG. 12 is a flow chart illustrating an exemplary process 1200 (e.g., a method) of wireless communication of a scheduled device (e.g., a scheduled entity, such as scheduled entity 1100 of FIG. 11) in a wireless communication network in accordance with some aspects of the disclosure. As described below, some or all illustrated features may be omitted in a particular implementation within the scope of the present disclosure, and some illustrated features may not be required for implementation of all embodiments. In some examples, the process 1200 may be carried out by the scheduled entity 1100 illustrated in FIG. 11. In some examples, the process 1200 may be carried out by any suitable apparatus or means for carrying out the functions or algorithms described herein.

At block 1202, the scheduled entity may receive a respective channel state information-reference signal (CSI-RS) on each of a first plurality of CSI-RS ports from a scheduling entity. In some examples, the first plurality of CSI-RS ports may be associated with the second plurality of TCI states on a per-CSI-RS port basis. In other examples, the first plurality of CSI-RS ports may be associated with the second plurality of TCI states on a per code division multiplex (CDM) group basis.

At block 1204, the scheduled entity may associate the first plurality of CSI-RS ports with a second plurality of transmission configuration indicator (TCI) states according to a rule. According to some aspects, the rule may be a fixed rule and the associating the first plurality of CSI-RS ports with the second plurality of TCI may further include associating each of a fourth plurality of sets of CSI-RS ports with a respective one of the second plurality of TCI states. In some examples each of the fourth plurality of sets of CSI-RS ports may include a series of contiguous CSI-RS ports selected from the first plurality of CSI-RS ports. In other examples, each of the fourth plurality of sets of CSI-RS ports may include any two or more CSI-RS ports selected from the first plurality of CSI-RS ports. In still other examples, a first of the fourth plurality of sets of CSI-RS ports may begin with a lowest numbered CSI-RS port and a last of the fourth plurality of sets of CSI-RS ports may end with a highest numbered CSI-RS port, both of the first plurality of CSI-RS ports.

In other aspects, the rule may be a configured rule and the associating the first plurality of CSI-RS ports with the second plurality of TCI states may further include associating the first plurality of CSI-RS ports with respective ones of the second plurality of TCI states. In one example, the configured rule may be received through radio resource control (RRC) signaling.

In some aspects, when associating the first plurality of CSI-RS ports with the second plurality of TCI states is performed on a per-code division multiplex (CDM) group basis, the scheduled entity may further divide the CSI-RS ports into a fifth plurality of CDM groups. In some examples, all CSI-RS ports associated with a given one of the fifth plurality of CDM groups may be associated with one of the second plurality of TCI states. In still other examples, when the rule is a fixed rule, associating the first plurality of CSI-RS ports with the second plurality of TCI states may also include associating each of the fifth plurality of CDM groups with a respective one of the second plurality of TCI states.

In some examples, each of the fifth plurality of CDM groups may include a series of contiguous set of CSI-RS ports selected from the first plurality of CSI-RS ports. Each of the fifth plurality of CDM groups may include any two or more CSI-RS ports selected from the first plurality of CSI-RS ports. In some aspects, a first of the fifth plurality of CDM groups may begin with a lowest numbered CSI-RS port and a last of the fifth plurality of CDM groups may end with a highest numbered CSI-RS port, both of the first plurality of CSI-RS ports.

In some aspects, when the rule is a configured rule, the associating the first plurality of CSI-RS ports with the second plurality of TCI states may further include associating the fifth plurality of CDM groups with respective ones of the second plurality of TCI states. The configured rule may be received, for example, through radio resource control (RRC) signaling.

In some examples, when two or more of the fifth plurality of CDM groups are associated with a first of the second plurality of TCI states, the scheduling entity may also number the CSI-RS ports of the two or more of the fifth plurality of CDM groups that are associated with the first of the second plurality of TCI states with a first contiguous series of CSI-RS port numbers, and number the CSI-RS ports associated with a second of the second plurality of TCI states with a second contiguous series of CSI-RS port numbers. The second contiguous series of CSI-RS port numbers may be different from the first contiguous series of CSI-RS port numbers. In some examples, the first contiguous series of CSI-RS port numbers and the second contiguous series of CSI-RS port numbers may be integers, and the integers of the first contiguous series may come before the integers of the second contiguous series.

At block 1206, the scheduled entity may determine a third plurality of precoding matrix indicators (PMIs) corresponding to the second plurality of TCI states, respectively.

At block 1208, the scheduled entity may transmit the third plurality of precoding matrix indicators (PMIs) corresponding to the second plurality of TCI states, respectively, to the scheduling entity. In some examples, the scheduled entity may transmit a sixth plurality of rank indicators (RIs) corresponding to the third plurality of PMls, respectively, to the scheduling entity. Still further, the scheduled entity may establish a configuration that transmits either: the third plurality of PMIs and the sixth plurality of RIs, or a joint PMI corresponding to the second plurality of TCI states, collectively, and a joint rank indicator (RI) corresponding to the joint PMI, to the scheduling entity, in accordance with an instruction received from the scheduled entity. The instruction may be received through radio resource control (RRC) signaling.

In other aspects, the scheduled entity may at least transmit at least: the third plurality of PMIs, or a joint PMI corresponding to the second plurality of TCI states, collectively, to the scheduling entity. In still other examples, the scheduled entity may also transmit a joint rank indicator (RI) corresponding to the joint PMI, to the scheduling entity.

In one configuration, the scheduled entity 1100 (e.g., a base station) for wireless communication includes means for receiving a respective channel state information-reference signal (CSI-RS) on each of a first plurality of CSI-RS ports from a scheduling entity, means for associating the first plurality of CSI-RS ports with a second plurality of transmission configuration indicator (TCI) states according to a rule, means for determining a third plurality of pre-coding matrix indicators (PMIs) corresponding to the second plurality of TCI states, respectively, and means for transmitting the third plurality of pre-coding matrix indicators (PMIs) corresponding to the second plurality of TCI states, respectively, to the scheduling entity. In one aspect, the aforementioned means may be the processor 1104 shown in FIG. 11 and configured to perform the functions recited by the aforementioned means. In another aspect, the aforementioned means may be a circuit, or any apparatus configured to perform the functions recited by the aforementioned means.

Of course, in the above examples, the circuitry included in the processor 1104 is merely provided as an example, and other means for carrying out the described functions may be included within various aspects of the present disclosure, including but not limited to the instructions stored in the computer-readable medium 1106, or any other suitable apparatus or means described in any one of the FIGS. 1, 2, 4, 5, 6, 9, and/or 11 and utilizing, for example, the processes and/or algorithms described herein in relation to FIG. 12.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. Additionally, the term “a and/or b” is intended to cover: a; b; and a and b. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication of a scheduling entity in a wireless communication network, the method comprising:
associating a first plurality of channel state information-reference signal (CSI-RS) ports with a second plurality of transmission configuration indicator (TCI) states according to a rule;
mapping the first plurality of CSI-RS ports to antenna elements of an antenna array in accordance with the rule;
transmitting a respective CSI-RS on each of the first plurality of CSI-RS ports from the antenna array to a scheduled entity; and
receiving a third plurality of pre-coding matrix indicators (PMIs) corresponding to the second plurality of TCI states, respectively, from the scheduled entity.

2. The method of claim 1, wherein the associating the first plurality of CSI-RS ports with the second plurality of TCI states further comprises:
performing the associating on a per-CSI-RS port basis.

3. The method of claim 2, wherein the rule is a fixed rule and the associating the first plurality of CSI-RS ports with the second plurality of TCI states further comprises:
associating each of a fourth plurality of sets of CSI-RS ports with a respective one of the second plurality of TCI states.

4-6. (canceled)

7. The method of claim 2, wherein the rule is a configured rule and the associating the first plurality of CSI-RS ports with the second plurality of TCI states further comprises:
associating the first plurality of CSI-RS ports with respective ones of the second plurality of TCI states.

8. (canceled)

9. The method of claim 1, wherein associating the first plurality of CSI-RS ports with the second plurality of TCI states is performed on a per-code division multiplex (CDM) group basis.

10. The method of claim 9, wherein the first plurality of CSI-RS ports is divided into a fifth plurality of CDM groups.

11-19. (canceled)

20. The method of claim 1, further comprising:
receiving a sixth plurality of rank indicators (RIs) corresponding to the third plurality of PMIs, respectively, from the scheduled entity.

21. The method of claim 20, further comprising:
configuring the scheduled entity to transmit either:
the third plurality of PMIs and the sixth plurality of RIs, or
a joint PMI corresponding to the second plurality of TCI states, collectively, and a joint rank indicator (RI) corresponding to the joint PMI, to the scheduling entity, in accordance with an instruction received from the scheduled entity.

22. (canceled)

23. The method of claim 1, further comprising receiving at least:
the third plurality of PMIs, or
a joint PMI corresponding to the second plurality of TCI states, collectively, from the scheduled entity.

24. The method of claim 23, further comprising:
receiving a joint rank indicator (RI) corresponding to the joint PMI, from the scheduled entity.

25-27. (canceled)

28. A method of wireless communication of a scheduled entity in a wireless communication network, the method comprising:
receiving a respective channel state information-reference signal (CSI-RS) on each of a first plurality of CSI-RS ports from a scheduling entity;
associating the first plurality of CSI-RS ports with a second plurality of transmission configuration indicator (TCI) states according to a rule;
determining a third plurality of pre-coding matrix indicators (PMIs) corresponding to the second plurality of TCI states, respectively; and
transmitting the third plurality of pre-coding matrix indicators (PMIs) corresponding to the second plurality of TCI states, respectively, to the scheduling entity.

29. The method of claim 28, wherein the first plurality of CSI-RS ports is associated with the second plurality of TCI states on a per-CSI-RS port basis.

30. The method of claim 29, wherein the rule is a fixed rule and the associating the first plurality of CSI-RS ports with the second plurality of TCI states further comprises:
associating each of a fourth plurality of sets of CSI-RS ports with a respective one of the second plurality of TCI states.

31-33. (canceled)

34. The method of claim 29, wherein the rule is a configured rule and the associating the first plurality of CSI-RS ports with the second plurality of TCI states further comprises:
associating the first plurality of CSI-RS ports with respective ones of the second plurality of TCI states.

35. (canceled)

36. The method of claim 28, wherein associating the first plurality of CSI-RS ports with the second plurality of TCI states is performed on a per-code division multiplex (CDM) group basis.

37. The method of claim 36, wherein the first plurality of CSI-RS ports is divided into a fifth plurality of CDM groups.

38-46. (canceled)

47. The method of claim 28, further comprising:
transmitting a sixth plurality of rank indicators (RIs) corresponding to the third plurality of PMIs, respectively, to the scheduling entity.

48. The method of claim 47, further comprising:
establishing a configuration that transmits either:
the third plurality of PMIs and the sixth plurality of RIs, or
a joint PMI corresponding to the second plurality of TCI states, collectively, and a joint rank indicator (RI) corresponding to the joint PMI, to the scheduling entity, in accordance with an instruction received from the scheduled entity.

49. (canceled)

50. The method of claim 28, further comprising transmitting at least:
the third plurality of PMIs, or
a joint PMI corresponding to the second plurality of TCI states, collectively, to the scheduling entity.

51. The method of claim 50, further comprising:
transmitting a joint rank indicator (RI) corresponding to the joint PMI, to the scheduling entity.

52-54. (canceled)
